(19) United States
(12) Patent Application Publication
(10) Pub. No.: US 2009/0221238 A1
(43) Pub. Date: Sep. 3, 2009

(54) TRANSMITTING APPARATUS AND TRANSMITTING METHOD OF BASE STATION, AND RECEIVING APPARATUS AND COMMUNICATION METHOD OF UE IN MOBILE COMMUNICATION SYSTEM

(75) Inventors: Young-Jo Ko, Daejeon (KR); Jae-Young Ahn, Daejeon (KR); Kwang-Soon Kim, Seoul (KR); Du-Ho Rhee, Seoul (KR)

Correspondence Address: CANTOR COLBURN, LLP, 20 Church Street, 22nd Floor, Hartford, CT, 06103, US

(73) Assignee: Electronics and Telecommunications Research Instit, Daejeon (KR)

(21) Appl. No.: 12/097,439

(22) PCT Filed: Dec. 5, 2006
(86) PCT No.: PCT/KR2006/005197

§ 371 Date: Sep. 3, 2008

(30) Foreign Application Priority Data
Dec. 13, 2005 (KR) 10-2005-0122601
Aug. 7, 2006 (KR) 10-2006-0074143

(51) Int. Cl. H04B 17/00

(52) U.S. Cl. 455/67.13

(57) ABSTRACT

A receiving apparatus of a UE transmits at least one channel information among a plurality of channel information to a transmitting apparatus of a base station according to an adaptive transmission method set for a received signal. In addition, the receiving apparatus transmits channel state information generated on the basis of the plurality of channel information to the transmitting apparatus with a relatively long interval. The transmitting apparatus transmits traffic data to the transmitting apparatus by using the received channel state information and at least one of channel information and one of a plurality of adaptive transmission methods. Accordingly, the amount of channel information transmitted to the transmitting apparatus can be modified in accordance with an adaptive transmission method set for a received signal, thereby minimizing the amount of channel information fed back from the receiving apparatus and increasing system capacity.

### TECHNICAL FIELD

The present invention relates to a transmitting apparatus in a base station and a transmission method thereof, and a receiving apparatus in a user equipment (UE) and a communication method thereof in a mobile communication system. More particularly, the present invention relates to an adaptive transmission method in a downlink of an orthogonal frequency division multiplexing access (OFDMA)-based mobile communication system.

### BACKGROUND ART

In general, each user equipment (UE) in an OFDMA-based mobile communication system has a different wireless channel environment. Therefore, the UE estimates channel state information transmitted from a base station and feeds back the estimated channel state information to the base station so as to increase performance and capacity of the OFDMA-based mobile communication system.

In more detail, when a transmitting end of the base station transmits a pilot or a preamble to a receiving end of the UE through a radio channel, the receiving end of the UE estimates a radio channel state by using the pilot or the preamble, estimates a signal to noise ratio (SNR) of the estimated radio channel state, and feeds back the estimated radio channel state and the SNR of the radio channel to the transmitting end of the base station in the OFDMA-based mobile communication system.

Then, the transmitting end of the base station adaptively transmits traffic data by applying a modulation method, an encoding method, and power allocation based on the SNR that is fed back to the transmitting end of the base station.

A downlink frame structure of the OFDMA-based mobile communication system is formed of a series of slots and each slot is formed by at least one symbol. Each slot includes a plurality of pilot symbols for channel estimation that are arranged dispersively, and a plurality of data channels. In case of multi-carrier system such as OFDMA, the pilot symbols are spread along both time and frequency domains. The receiving end of the UE estimates a channel state by using the pilot symbol, and generates channel state information by using the estimated channel state.

However, when estimating a channel estimate by using a pilot symbol of an n-th slot, the receiving end of the UE may estimate a channel state after a predetermined delay due to a delay in a channel estimation filter. In addition, the receiving end of the UE generates channel state information using the outdated channel state and transmits the generated channel state information to the transmitting end of the base station through an uplink channel.

Accordingly, a time difference between channel state estimation in the receiving end of the UE and actual data transmission in the transmitting end of the base station corresponds to at least more than two slot times, and one or two slots may be added to the time difference depending on a frame structure, a delay in a channel estimation filter in a receiving apparatus, and a time for a transmission/receiving operation between the base station and the UE. As described, a channel state may be changed due to the time difference between the SNR estimation in the receiving end of the UE and the data transmission in the transmitting end of the base station.

As a related technology, a channel prediction method may be used for predicting a channel state to be used for data transmission in the transmitting end of the base station. That is, a receiving end of the UE predicts future channel state information by using information from previous channel state information through to current channel state information that the UE has received, and transmits feedback to a transmitting end of the base station. Then, the transmitting end of the base station performs data transmission by using the predicted channel state information.

Such a method has been proposed by A. Duel-Hallen, S. Hu, and H. Hallen, in “Long-range prediction of fading signals” (IEEE Signal Processing Magazine, vol. 17, pp. 62-75, May 2000). However, the predicted channel state information includes prediction errors, and therefore, system performance may experience severe degradation when transmit power is determined by compensating a required signal to noise ratio (SNR) with only a predicted SNR.

As another prior art, a method for deriving an error bit rate (BER) using statistic characteristics of predicted channel state information and calculating transmit power by using the derived BER has been disclosed by S. Falahati, A. Svensson, T. EKman, and M. Sternad (entitled, “Adaptive Modulation Systems for Predicted Wireless Channels,” IEEE Trans., Vol. 52, pp. 307-316, February 2004). However, since this method is aimed at utilization of adaptive modulation by a single user of a single subcarrier system in a flat fading environment, this method cannot be applied to a mobile communication system including various channel environments, user equipment using various channel state information generation algorithms, and variation in mobile speed.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide a transmitting apparatus of a base station and a transmission method thereof, and a receiving apparatus of a UE and a communication method thereof having the advantage of performing efficient adaptive transmission in a mobile communication system under a multi-path radio channel environment.

### Technical Solution

An exemplary receiving apparatus according to an embodiment of the present invention is provided to a user equipment (UE) that communicates with a base station in a mobile communication system in a multi-path radio channel environment.

The receiving apparatus includes a path estimator, a channel estimator, an average predictor, a variance predictor, long-term channel information generator, and a transmitter. The path estimator estimates a receiving path from a received signal. The channel estimator estimates a channel for each of the estimated receiving paths. The average predictor generates predicted channel average information after a minimum transmission delay by using the estimated channel. The variance predictor generates predicted channel variance information by using the predicted channel average information. The long-term channel information generator generates an average signal to noise ration (SNR) by using the estimated channel and generates statistical information on an error of the predicted channel average information by using the predicted channel average information. The transmitter transmits at least one of the predicted channel average information, the predicted channel variance information, the number of receiving paths, and the statistical information on the predicted channel average information error, as well as the average SNR.

An exemplary transmitting apparatus according to another embodiment of the present invention is provided to a base station for transmitting a signal to a UE of a mobile communication system in a multi-path radio channel environment.

The transmitting apparatus includes a receiver, a transmit power controller, a scheduler, and a transmission controller. The receiver receives at least one of an average signal to noise ratio (SNR), predicted channel average information, predicted channel variance information, the number of receiving paths, and statistical information on an error in the predicted channel average information. The transmit power controller acquires transmit power for each UE and each encoding/modulation method by using information received at the receiver. The scheduler determines an encoding/modulation method for each UE and selects a UE to be served. The transmission controller encodes and modulates the signal according to the determined encoding/modulation method and transmits the encoded and modulated signal according to a predetermined adaptive transmission method.

An exemplary communication method according to another exemplary embodiment of the present invention is provided to a receiving apparatus of a UE for communication with a base station of a mobile communication system in a multi-path radio channel environment. The communication method includes: a) estimating a channel for each receiving path from a received signal; b) generating a plurality of channel state information by using the received signal and the channels respectively corresponding to the receiving paths; and c) transmitting at least a portion of the plurality of channel state information to the base station.

An exemplary transmission method according to another embodiment of the present invention transmits a signal from a transmitting apparatus of a base station to a UE in a mobile communication system under a multi-path radio channel environment. The transmission method includes: a) partially or fully receiving a plurality of channel information from the UE; b) acquiring transmit power for an encoding/modulation method of each UE by using the partially received channel information; c) determining an encoding/modulation method for each UE, and selecting a UE to be served; and d) encoding/modulating the signal according to the determined encoding/modulation method and transmitting the encoded/modulated signal to the UE.

### ADVANTAGEOUS EFFECTS

Accordingly to the present invention, a UE in a good channel state can acquire a gain by feeding back channel information, and a UE in a bad channel state can reduce the amount of feedback information without causing performance degradation by feeding back only effective channel information for the bad channel state.

### DESCRIPTION OF DRAWINGS

FIG. 1 shows a transmitting apparatus of a base station and a receiving apparatus of a mobile station in an OFMDA-based mobile communication system according to a first exemplary embodiment of the present invention.

FIG. 2 shows the receiving apparatus of the mobile station according to the first exemplary embodiment of the present invention in more detail.

FIG. 3 is a flowchart of a process of transmitting channel state information in the receiving apparatus of the mobile station according to the first exemplary embodiment of the present invention.

FIG. 4 shows the transmitting apparatus of the base station according to the first exemplary embodiment of the present invention in more detail.

FIG. 5 is a flowchart of a process for transmitting traffic data in the transmitting apparatus of the base station according to the first exemplary embodiment of the present invention.

FIG. 6 schematically shows a structure of a transmitting apparatus of a base station and a receiving apparatus of a mobile station in a mobile communication system according to a second exemplary embodiment of the present invention.

FIG. 7 is a flowchart of an operation of the transmitting apparatus of the base station and the receiving apparatus of the mobile station in the wireless communication system according to the second exemplary embodiment of the present invention.

### BEST MODE

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

In addition, unless explicitly described to the contrary, the word “comprise” or variations such as “comprises” or “comprising” will be understood to imply the inclusion of stated elements but not the exclusion of any other elements.

A base station transmitting apparatus and a transmission method thereof, and a UE receiving apparatus and a communication method thereof in a mobile communication system according to an exemplary embodiment of the present invention will now be described in more detail with reference to the accompanying drawings. According to a first exemplary embodiment of the present invention, a mobile communication system is an OFDMA-based mobile communication system.

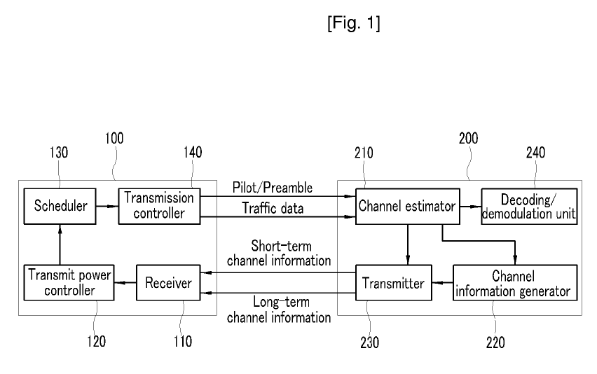

FIG. 1 shows a transmitting apparatus of a base station and a receiving apparatus of a user equipment (UE) in an OFDMA-based mobile communication system according to the first exemplary embodiment of the present invention.

As shown in FIG. 1, a transmitting apparatus 100 of a base station includes a receiver 110, a scheduler 130, a transmit power controller 120, and a transmission controller 140, and a receiving apparatus 200 of the UE includes a channel estimator 210, a channel information generator 220, a transmitter 230, and a demodulating/decoding unit 240.

The channel estimator 210 estimates a channel by using a pilot or a preamble transmitted from the transmitting apparatus 100, and the channel information generator 220 generates predicted channel average information and predicted channel variance information after a minimum transmission delay D by using the estimated channel, and transmits the information as short-term channel information to the transmitter 230.

The channel information generator 220 separates a signal by estimating a receiving path from a received signal, acquires statistical characteristic information of an error in the predicted channel average information by using predicted channel average information and substantial channel state information that can be obtained after the delay D passes, and obtains an average signal to noise ratio (SNR) by using the channel state estimated by the channel estimator 210.

The channel information generator 220 transmits a total number of receiving paths, statistical characteristic information on a channel prediction error, and the average SNR as long-term channel information to the transmitter 230. Herein, the minimum transmission delay D indicates a difference between a slot time of channel estimation and a slot time of traffic data transmission when the transmitting apparatus 100 of the base station transmits traffic data with the highest priority, and the difference may vary depending on a system.

The transmitter 230 transmits channel state information generated by the channel state information generator 220 to the transmitting apparatus 100 of the base station.

The demodulating/decoding unit 240 demodulates and decodes the traffic data transmitted from the transmitting apparatus 100 of the base station.

The receiver 110 receives at least a portion of the short-term channel information or a portion of the long-term channel information transmitted from the receiving apparatus 200, and delivers the received information to the transmit power controller 120. The transmit power controller 120 determines transmit power for a user-desired encoding/modulating algorithm by using the short-term channel information and the long-term channel information, and the scheduler 130 determines an appropriate encoding/modulation algorithm and selects users to be served.

The transmission controller 140 encodes/modulates traffic data by using the determined encoding/modulation algorithm and transmits the encoded/modulated traffic data to the receiving apparatus 200.

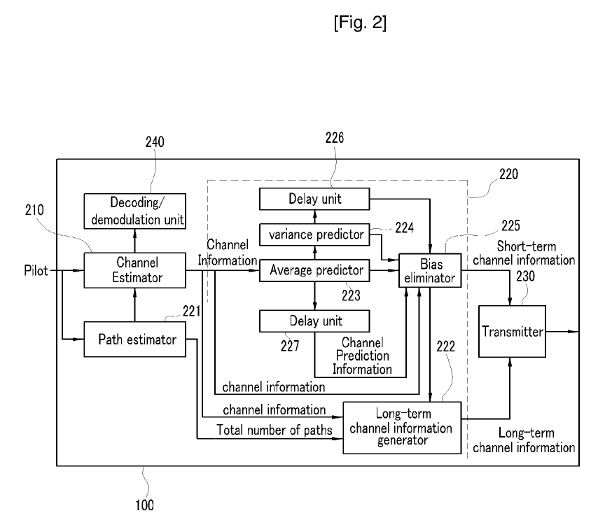

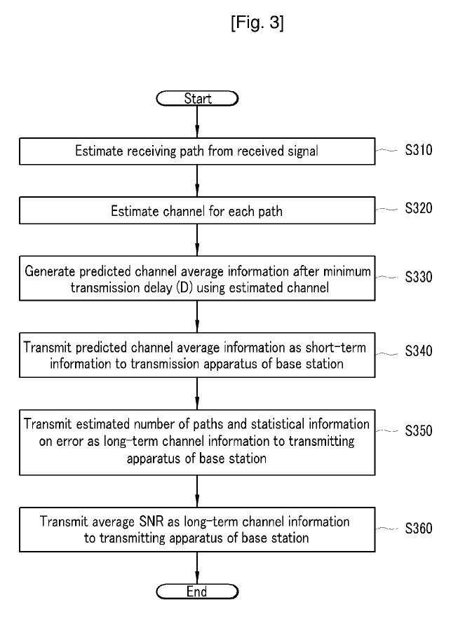

FIG. 2 shows a detailed configuration of the UE receiving apparatus according to the first exemplary embodiment of the present invention, and FIG. 3 is a flowchart of channel information transmission in the UE receiving apparatus according to the first exemplary embodiment of the present invention.

As shown in FIG. 2 and FIG. 3, the channel information generator 220 includes a path estimator 221, a long-term channel information generator 222, an average predictor 223, a variance predictor 224, a bias eliminator 225, and delay units 226 and 227.

The path estimator 221 estimates a receiving path from a received signal and separates a signal from each of the receiving paths, in step S310. The channel estimator 210 estimates a channel state for each receiving path from the received signal, in step S320.

The long-term channel information generator 222 receives a total number of estimated receiving paths L from the path estimator 221 and forwards L as long-term channel information to the transmitting apparatus 100, in step S350.

The average predictor 223 uses the channel estimated by the channel estimator 210 to predict a channel state, including the minimum transmission delay D, through a prediction filter (not shown) as given in Math Figure 1. That is, the average predictor 223 predicts the channel state, including the minimum transmission delay D, based on information on a current channel state and P outdated channel states, in step S330.

ĥₗ[n+D]=f(hₗ[n],hₗ[n−1], . . . , hₗ[n−P+1]) [Math Figure 1]

Where h₁[n] denotes a conjugate channel at the time n in the l-th path, P denotes a degree of the average predictor 223, and f denotes a prediction filter. Hereinafter, in order to simplify notations, a time parameter is set to n+D when the parameter is omitted. That is, ĥₗ=ĥₗ[n+D].

In addition, the transmitting apparatus 100 can determine transmit power not by a complex value of required transmit power but by a square of an absolute value of hi, and therefore, the average predictor 223 obtains a combined power value as given in Math Figure 2.

$${\hat{p}}_{biased} = {\sum }_{l = 0}^{L - 1} {\vert {\hat{h}}_{l} \vert}^{2} \qquad [ Math Figure 2 ]$$

However, since the power value calculated through Math Figure 2 is biased, the bias eliminator 225 should eliminate the bias by using an average value of the predicted channel average information and the substantial channel state information as given in Math Figure 3.

\hat{p}=\hat{p}_{biased}+E{p−\hat{p}_{biased}} [Math Figure 3]

Where E{p−\hat{p}_{biased}} denotes a moving average obtained by accumulating a difference between the substantial channel state estimated at the time n+D and the channel state estimated at the time n for a longer period of time.

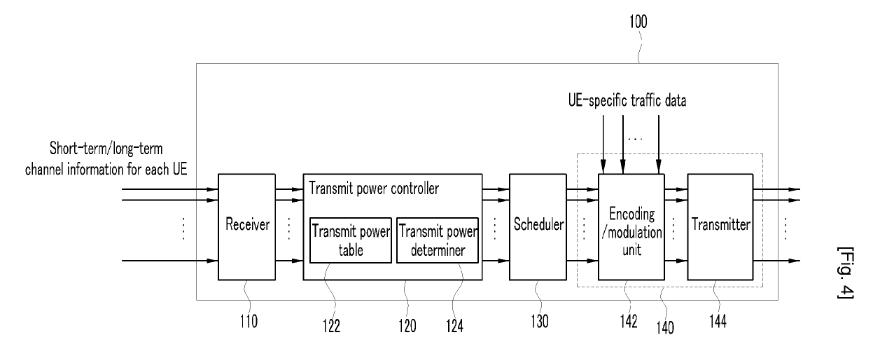

As a result, the bias eliminator 225 may use a moving average scheme to obtain the average moving. However, when a power of a pilot is Pₚᵢₗₒₜ, the receiving apparatus 200 does not know the power of the pilot, and therefore the average predictor 223 obtains an average SNR that is proportional to \hat{p} as given in Math Figure 4. The average SNR, including the minimum transmission delay D, is transmitted as the short-term channel information to the transmitting apparatus 100 of the base station, in step S340. Such an SNR, including the minimum transmission delay D, obtained through Math Figure 4 will be referred to as “predicted channel average information” in the following description.

$$\begin{matrix}\begin{matrix}\hat{SNR} = \frac{{P}_{pilot} \hat{p}}{2 {σ}_{n}^{2}} \\ = \frac{{P}_{pilot} {\hat{p}}_{biased}}{2 {σ}_{n}^{2}} + E \{ \frac{{P}_{pilot} p}{2 {σ}_{n}^{2}} - \frac{{P}_{pilot} {\hat{p}}_{biased}}{2 {σ}_{n}^{2}} \}\end{matrix} & [ Math Figure 4 ]\end{matrix}$$

Where σₙ² denotes noise variance.

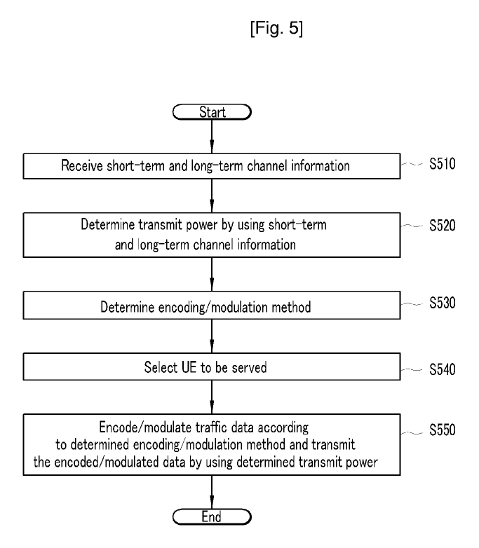

The variance predictor 224 performs fast Fourier transform (FFT) on the channel state information ĥₗ, including the minimum transmission delay D, to obtain a channel on the frequency axis and channel power variance [symbol] on the frequency axis. However, the substantial channel power variance that the variance predictor 224 obtains is [symbol] Since the channel power variance [symbol] of the frequency axis is also biased, the bias eliminator 225 eliminates the bias as given in Math Figure 5 and reports the bias-eliminated channel power variance as short-term channel information. The bias-eliminated channel power variance will be referred to as “predicted channel variance information”.

$$\hat{{σ}_{SNR}^{2}} = \tilde{{σ}_{SNR}^{2}} + E \{ {σ}_{SNR}^{2} - \tilde{{σ}_{SNR}^{2}} \} \qquad [ Math Figure 5 ]$$

In addition, the long-term channel information generator 222 receives a difference (SNR− [symbol] ) between the substantial channel state information and the predicted channel average information from the bias eliminator 225 and obtains statistical information on a channel prediction error, and transmits the statistical information as one of the long-term channel state information to the transmitting apparatus 100.

In this case, the long-term channel information generator 222 transmits the total number of paths L estimated by the path estimator 221 and an average SNR obtained by using a channel state estimated by the channel estimator 210 as the long-term channel information to the transmitting apparatus 100, in steps S350 and S360.

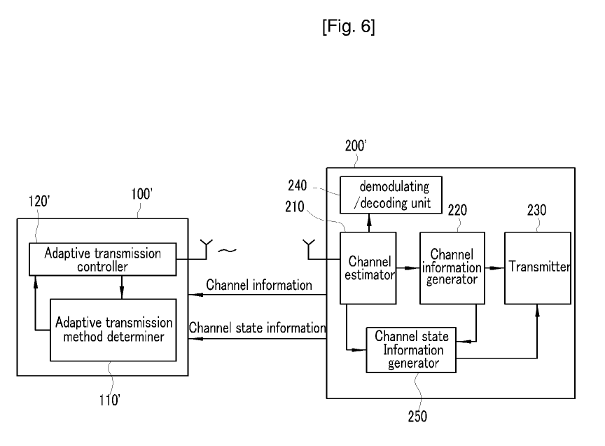

In this case, the long-term channel information generator 222 transmits the average SNR to the transmitting apparatus 100 with an interval that is longer than an interval of the transmission of the statistical information on the channel prediction error and the total number of paths L. Herein, the statistical information on the channel prediction error can be used to calculate an average value of |SNR− [symbol] |² for a long period of time by using the moving average method as given in Math Figure 6.

$${σ}_{ɛ , SNR}^{2} = E \{ {\vert \frac{{P}_{pilot}}{2 {σ}_{n}^{2}} ( p - \hat{p} ) \vert}^{2} \} = E \{ {\vert SNR - \hat{SNR} \vert}^{2} \} \qquad [ Math Figure 6 ]$$

That is, a channel state in the time (n+D) is predicted at the time n, and the channel estimator 210 estimates a substantial channel state at the time (n+D). In addition, the average predictor 223 transmits substantial channel power P to the bias eliminator 225. In order to calculate E{(p−\hat{p})} of Math Figure 6, the delay units 226 and 227 are required to transmit channel power that was predicted at the time n to the bias eliminator 225 at the time (n+D).

The delay units 226 and 227 respectively delay outputting of channel state information that have been predicted by the average predictor 223 and the variance predictor 224 for a predetermined time period, and output the delayed channel state information to the bias controller 225.

FIG. 4 shows a detailed diagram of the transmitting apparatus of the base station according to the first exemplary embodiment of the present invention, and FIG. 5 is a flowchart of a traffic data transmission process of the transmitting apparatus of the base station according to the first exemplary embodiment of the present invention.

As shown in FIG. 4 and FIG. 5, the receiver 110 receives the short-term channel information and the long-term channel information transmitted from the receiving apparatus 200 of the UE, and transmits at least a portion of the long-term channel information and at least a portion of the short-term channel information transmitted from the receiving apparatus 200 of the UE to the transmit power controller 120 according to an assigned adaptive transmission method, in step S510.

In addition, the transmit power controller 120 includes a transmit power table 122 and a transmit power determiner 124. The transmit power table 122 stores a transmit power value according to an average deviation region for each encoding/modulation method, and the values stored in the transmit power table 122 are obtained by a simulation.

In the simulation, the predicted channel variance information [symbol] which is one of the short-term channel information, is quantized for each included in the short-term channel information of each encoding/modulation method is quantized with a constant interval for each encoding/modulation method, and the predicted channel average information [symbol] the statistical information σ_{ε,SNR}² on the error in the predicted channel average information [symbol] and the number of paths L are quantized with a constant interval such that the transmit power table 122 becomes a table of required transmit power in three-dimensions.

The transmit power determiner 124 determines transmit power for an encoding/modulation method of each user by using the channel state information transmitted from the receiver 110, in step S520. That is, the transmit power determiner 124 searches for transmit power that corresponds to the long-term channel information and the short-term channel information from the transmit power table 122 for each encoding/modulation method. Herein, the long-term channel information includes the statistic information σ_{ε,SNR}² of the error in the predicted channel average information [symbol] and the number of receiving paths L, and the short-term channel information includes the predicted channel variance information [symbol] and the predicted channel average information

[symbol]

The scheduler 130 selects a proper encoding/modulation method for each user, and selects users to be served, in steps S530 and S540. In this case, the scheduler 130 selects an encoding/modulation method having the highest transmission rate among encoding/modulation methods requiring transmission power less than the maximum available power.

The transmission controller 140 includes an encoding/modulation unit 142 and a transmitter 144, and the encoding/modulation unit 142 encodes/modulates traffic data by using an encoding/modulation method that is appropriate for traffic data of the user selected by the scheduler 130, in step S540.

The transmitter 144 transmits the encoded/modulated traffic data to the receiving apparatus 200, in step S540.

As described, the transmitting apparatus 100 according to the first exemplary embodiment of the present invention receives the short-term channel information and the long-term channel information from the receiving apparatus 200 and performs adaptive modulation so that system performance can be improved.

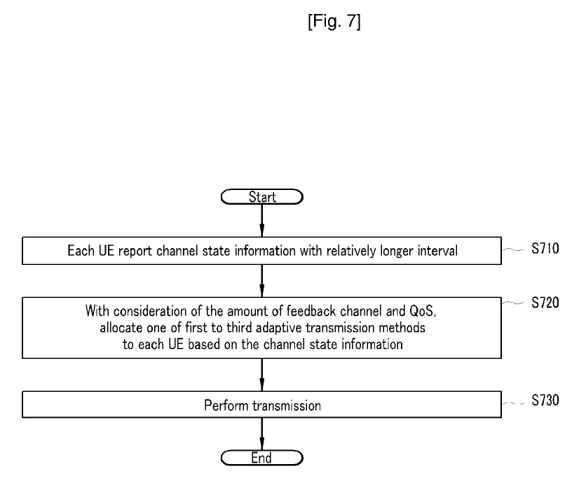

However, when the error in the predicted channel average information [symbol] increases, the system performance may be the same as in the adaptive transmission without using the predicted channel average information [symbol] Therefore, receiving apparatuses 200 of all UEs must report both long-term channel information and short-term channel information to the transmitting apparatus 100 of the base station. An exemplary embodiment aiming to increase system capacity while minimizing the amount of fed-back channel state information will be described in more detail with reference to FIG. 6 and FIG. 7.

FIG. 6 schematically shows structures of a transmitting apparatus of a base station and a receiving apparatus of a UE in an OFDMA-based mobile communication system according to a second exemplary embodiment of the present invention, and FIG. 7 is a flowchart of the transmitting apparatus and the receiving apparatus in the OFDMA-based communication system according to the second exemplary embodiment of the present invention.

As shown in FIG. 6 and FIG. 7, a receiving apparatus 200′ of the UE is the same as that of the first exemplary embodiment of the present invention, except that the receiving apparatus 200′ further includes a channel state information generator 250 in addition to the constituent elements of the receiving apparatus 200 of the first exemplary embodiment. The channel state information generator 250 compares the statistical information σ_{ε,SNR}² on the error of the predicted channel average information [symbol] with predetermined threshold values, and reports channel state information corresponding to a range between the predetermined threshold values with an interval that is longer than an interval of the transmission of the average SNR to the transmitting apparatus 100 of the base station, in step S710.

Since the channel state information is fed back to the transmitting apparatus 100 of the base station with a relatively longer interval, an overhead in the feedback information can be ignored. That is, as given in Math Figure 7, the channel state information generator 250 compares a value ν with predetermined threshold values ν_{th,1}, ν_{th,2}, wherein the value is obtained by dividing the statistical information σ_{ε,SNR}² on the error of the predicted channel average information [symbol] with the average SNR E{SNR}, which is substantial channel state information. In this case, the threshold value ν_{th,1} the is set to be smaller than the threshold value ν_{th,2}

$$ν = \frac{{σ}_{ɛ , SNR}^{2}}{E \{ SNR \}} \qquad [ Math Figure 7 ]$$

Where E{SNR} may represent the average SNR generated by using the channel state estimated by the channel estimator 210. In addition, the channel state information generator 250 compares the value ν with the predetermined threshold values ν_{th,1}, ν_{th,2}, and reports channel state information corresponding to ν≦ν_{th,1}, ν_{th,1}<ν≦ν_{th,2}, and ν_{th,2}<ν to the transmitting apparatus 100 of the base station with an interval that is longer than the interval of transmission of the statistical information on the error of the predicted channel average information. Herein, the threshold values ν_{th,1}, ν_{th,2} are determined by a simulation.

According to the second exemplary embodiment of the present invention, a transmitting apparatus 100′ of the base station may adopt three adaptive transmission methods, respectively called a “first adaptive transmission method”, a “second adaptive transmission method”, and a “third transmission method”. The first adaptive transmission method may be used when ν≦ν_{th,1}, the second adaptive transmission method may be used when ν_{th,1}<ν≦ν_{th,2}, and the third adaptive transmission method may be used when ν_{th,2}<ν.

That is, the first adaptive transmission method uses predicted channel average information [symbol] predicted channel variance information [symbol] statistical information σ_{ε,SNR}² on the error of the predicted channel average information [symbol] and the number of receiving paths L (see FIG. 4). The second adaptive transmission method uses the short-term channel information including the predicted channel average information [symbol] statistical information σ_{ε,SNR}² on the error of the predicted channel average information [symbol] and the number of receiving paths L, excluding the predicted channel variance information [symbol] since the system performance is not improved even though the predicted channel variance information [symbol] is used compared to the system performance when using the predicted channel variance information

[symbol]

Since the predicted channel variance information [symbol] is not used, the transmit power table 122 has a target transmit power table for each encoding/modulation method, wherein the target transmit power table is a three-dimensional table generated by quantizing the predicted channel average information [symbol] the statistical information σ_{ε,SNR}² on the error of the predicted channel average information [symbol] and the number of receiving paths I, with respect to a constant interval.

The third adaptive transmission method uses only the average SNR E{SNR} since there is no difference in the system performance when the predicted channel average information is used and when predicted channel average information is not used.

As shown in FIG. 6 and FIG. 7, the transmitting apparatus 100′ according to the second exemplary embodiment of the present invention includes an adaptive transmission method determiner 110′ and an adaptive transmission controller 120′.

The adaptive transmission method determiner 110′ is reported with channel state information by the receiving apparatus 200 of each UE, determines an appropriate adaptive transmission method for the respective receiving apparatuses 200 in consideration of the amount of feedback channel and a quality of service (QoS) among various adaptive transmission methods, and provides the determined adaptive transmission method to the adaptive transmission controller 120′, in step S720.

The adaptive transmission controller 120′ corresponds to the receiver 100, the transmit power controller 120, the scheduler 130, and the transmission controller 140 of FIG. 1 and FIG. 4. Herein, the adaptive transmission method determiner 110′ may be placed between the receiver 110 and the transmit power controller 120. The adaptive transmission controller 120′ selects an encoding/modulation method by using channel state information allocated in accordance with an adaptive transmission method that has been determined for each user among the various adaptive transmission methods, and transmits user-specific traffic data to the receiving apparatus 200.

In this case, the adaptive transmission controller 120′ uses the same transmission method described in the first exemplary embodiment when the first adaptive transmission method is used (see FIG. 4). When the second adaptive transmission method is used, the predicted channel variance information [symbol] is not used, and therefore, the adaptive transmission controller 120′ uses only the predicted channel average information [symbol] among the short-term channel information and acquires a target transmit power by using the transmit power table 122 that has been formed by quantizing predicted channel average information [symbol] and statistical information σ_{ε,SNR}² on errors on the predicted channel average information [symbol] for each encoding/modulation, and transmits traffic data with the acquired target transmit power.

In addition, the adaptive transmission controller 120′ determines transmit power that satisfies a targeted packet error rate by using the reported average SNR E{SNR} and transmit traffic data, when the third adaptive transmission method is used.

In addition, the adaptive transmission controller 120′ may individually use the three adaptive transmission methods for each user. For example, when a plurality UEs exist with a good channel state, the first adaptive transmission method is allocated to a portion of the UEs and the second adaptive transmission method is allocated to the rest of the UEs since the amount of feedback channel state information is limited.

The above-described exemplary embodiments of the present invention can be realized not only through a method and an apparatus, but also through a program that can perform functions corresponding to configurations of the exemplary embodiments of the present invention or a recording medium storing the program, and this can be easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A receiving apparatus of user equipment (UE) that communicates with a base station in a mobile communication system under a multi-path radio channel environment, the receiving apparatus comprising:
a path estimator for estimating a receiving path from a received signal;
a channel estimator for estimating a channel for each of the estimated receiving paths;
an average predictor for generating predicted channel average information after a minimum transmission delay by using the estimated channel;
a variance predictor for generating predicted channel variance information by using the predicted channel average information;
a long-term channel information generator for generating an average signal to noise ratio (SNR) by using the estimated channel, and generating statistical information on an error of the predicted channel average information by using the predicted channel average information; and
a transmitter for transmitting at least one of the predicted channel average, the predicted channel variance information, the number of receiving paths, the statistical information on the error of the predicted channel average, and the average SNR.

2. The transmitting apparatus of claim 1, further comprising a channel state information generator for generating channel state information based on the average SNR and the statistical information on the predicted channel average information error and transmitting the generated channel state information to the base station through the transmitter,
wherein the transmitting apparatus determines an adaptive transmission method to be used for the received signal in the base station among a plurality of adaptive transmission methods based on the channel state information.

3. The transmitting apparatus of claim 2, wherein the transmitter determines at least one information to be transmitted to the base station according to the adaptive transmission method determined for the received signal.

4. The transmitting apparatus of claim 3, wherein the transmitter transmits:
the predicted channel average information, the predicted channel variance information, the number of receiving paths, and the statistical information on the error of the predicted channel average information to the base station when a first adaptive transmission method is selected from among the plurality of adaptive transmission methods;
transmits the predicted channel average information, the number of receiving paths, and the statistical information on the error of the predicted channel average information to the base station when a second adaptive transmission method is selected from among the plurality of adaptive transmission methods; and
transmits the average SNR to the base station when a third adaptive transmission method is selected from among the plurality of adaptive transmission methods.

5. The transmitting apparatus of claim 4, wherein the transmitter transmits the predicted channel average information and the predicted channel variance information with a first interval, transmits the number of receiving paths and the statistical information on the error of the predicted channel average information with a second interval that is longer than the first interval, and transmits the average SNR with a third interval that is longer than the second interval.

6. The transmitting apparatus of claim 5, wherein the transmitter reports the channel state information with a fourth interval that is longer than the third interval.

7. The transmitting apparatus of claim 1, further comprising a decoding/demodulation unit for demodulating and decoding data by using the channel state information estimated from the received signal.

8. A transmitting apparatus of a base station for transmitting a signal to user equipment (UE) in a mobile communication system under a multi-path wireless channel environment, the transmitting apparatus comprising:
a receiver for receiving at least one of an average signal to noise ratio (SNR), predicted channel average information, predicted channel variance information, the number of receiving paths, and statistical information on an error in the predicted channel average information from the UE;
a transmit power controller for acquiring transmit power for each UE and for each encoding/modulation method by using information received from the receiver;
a scheduler for determining an encoding/modulation method for each UE and selecting UEs to be served; and
a transmission controller for encoding and modulating the signal according to the determined encoding/modulation method and transmitting the encoded and modulated signal according to a previously determined adaptive transmission method.

9. The transmitting apparatus of claim 8, wherein the receiver additionally receives channel state information from the UE,
wherein the transmitting apparatus further comprises an adaptive transmission method determiner for determining one of a plurality of adaptive transmission methods from the information received from the receiver, and transmitting the determined adaptive transmission method to the transmit power controller.

10. The transmitting apparatus of claim 9, wherein the transit power controller comprises:
a table storing transmit power for the respective encoding/modulation methods; and
a transmit power determiner for determining transmit power for an encoding/modulation method of each UE by using the table.

11. The transmitting apparatus of claim 8, wherein the transmission controller uses:
the predicted channel average information, the predicted channel variance information, the number of receiving paths, and the statistical information on the error of the predicted channel average information when a first adaptive transmission method is selected from among the plurality of adaptive transmission methods;
the predicted channel average information, the predicted channel variance information, and the statistical information on the error of the predicted channel average information when a second adaptive transmission method is selected from among the plurality of adaptive transmission methods; and
the average SNR when the third adaptive transmission method is selected from among the plurality of adaptive transmission methods.

12. A communication method for a receiving apparatus of user equipment (UE) to communicate with a base station in a mobile communication system under a multi-path wireless channel environment, the communication method comprising:
a) estimating a channel for each receiving path from a received signal;
b) generating a plurality of channel information by using the received signal and the channels respectively corresponding to the receiving paths; and
c) transmitting at least a portion of the plurality of channel state information to the base station.

13. The communication method of claim 12, wherein b) comprises:
acquiring the number of receiving paths from the received signal;
generating an average signal to noise ratio (SNR) by using the channel estimated for each of the receiving paths;
generating predicted channel average information, after a transmission delay, by using the channel estimated for each of the receiving paths;
generating predicted channel variance information from the generated predicted channel average information; and
generating statistical information on an error in the predicted channel average information from the generated predicted channel variance information.

14. The communication method of claim 13, wherein c) comprises differentiating the number of channel state information to be transmitted to the base station among the plurality of channel information depending on an adaptive transmission method applied to the receiving signal.

15. The communication method of claim 14, further comprising generating channel state information by using the plurality of channel information and transmitting the generated channel state information to the base station,
wherein the adaptive transmission method to be applied to the received signal in the base station is selected from among a plurality of adaptive transmission methods according to the channel state information.

16. The communication method of claim 15, wherein the channel state information is transmitted with an interval that is longer than an interval of transmission of the plurality of channel information.

17. The communication method of claim 11, further comprising demodulating and decoding the received signal by using the estimated channel.

18. A transmission method for transmitting a signal from a transmitting apparatus of a base station to user equipment (UE) in a mobile communication system under a multi-path wireless channel environment, the transmission method comprising:
a) partially receiving a plurality of channel information from the UE;
b) acquiring transmit power for an encoding/modulation method of each UE by using the partially received channel information;
c) determining an encoding/modulation method for each UE, and selecting UE to be served; and
d) encoding/modulating the signal according to the determined encoding/modulation method and transmitting the encoded/modulated signal to the UE.

19. The transmitting method of claim 18, further comprising, between the steps of a) and b):
receiving channel state information generated on the basis of the plurality of channel information from the UE; and
determining one of a plurality of adaptive transmission methods by using the channel state information and the partially received channel information.

20. The transmitting method of claim 19, wherein the plurality of channel information includes an average signal to noise ratio (SNR), predicted channel average information, predicted channel variance information, the number of receiving paths, and statistical information on an error in the predicted channel average information, which are obtained from the UE,
and among the plurality of adaptive transmission methods:
a first adaptive transmission methods uses the predicted channel average information, the predicted channel variance information, the number of receiving paths, and the statistical information on the error in the predicted channel average information;
a second adaptive transmission method uses the predicted channel average information, the number of receiving paths, and the statistical information on the error in the predicted channel average information; and
a third adaptive transmission method uses the average SNR among the plurality of channel information.
